(19) United States
(12) Patent Application Publication
(10) Pub. No.: US 2023/0079111 A1
(43) Pub. Date: Mar. 16, 2023

(54) FOLDING DEVICE, COMPARTMENT COVER AND AUTOMOBILE

(71) Applicant: Shanghai Yinta NetWork Technology Co., Ltd, Shanghai (CN)

(72) Inventor: Junling BAO, Shanghai (CN)

(73) Assignee: Shanghai Yinta NetWork Technology Co., Ltd, Shanghai (CN)

(21) Appl. No.: 17/893,722

(22) Filed: Aug. 23, 2022

(30) Foreign Application Priority Data
Sep. 13, 2021 (CN) 202122206370.9

(51) Int. Cl. B60J 5/14

(52) U.S. Cl. CPC B60J 5/14

(57) ABSTRACT

Provided are a folding device, a compartment cover, and an automobile, belonging to the technical field of automobile accessories. The automobile includes the compartment cover. The compartment cover includes a folding device and plates disposed on two sides of the folding device. The folding device includes a pivot profile, a connection profile, and a rolling element. The connection profile is connected to each of two sides of the pivot profile. One of the pivot profile or the connection profile is provided with an accommodation recess. The other one of the pivot profile or the connection profile is provided with an engaging portion. The engaging portion rotates in the accommodation recess. The rolling element is rotatably disposed between the inner wall of the accommodation recess and the engaging portion.

### CROSS-REFERENCE TO RELATED APPLICATION

This application claims priority to Chinese Patent Application No. 2021222063709 filed Sep. 13, 2021, the disclosure of which is incorporated herein by reference in its entirety as if fully set forth.

### TECHNICAL FIELD

The present disclosure relates to the technical field of automobile accessories and, in particular, to a folding device, a compartment cover, and an automobile.

### BACKGROUND

To avoid cargoes in an automobile compartment from being damaged by moisture or contaminated by dust in severe weather, causing irreparable economic losses, some automobiles may be equipped with a compartment cover disposed above a compartment to block rain, snow or dust, so as to protect cargoes carried in the compartment. For the convenience of stowing and usage, some compartment covers are each typically designed as several cover plates, two adjacent ones of which can be folded relative to each other by rotation, so that when the compartment cover is not needed, each cover plate can be folded, thereby stowing the compartment cover.

To facilitate stowing the compartment cover, in the related art, typically, two adjacent cover plates are connected by using a securing shaft connection device such as a hinge. After one cover plate is connected to another adjacent cover plate by using the securing shaft connection device, the cover plates can be rotatably folded, thereby stowing the compartment cover. However, the rotation jamming of the existing securing shaft often occurs during use, and the cover plates are easy to slip out of the shaft cavity where the securing shaft is located. Moreover, after a long time of wear and tear of the securing shaft, the water flow may seep into the interior of the compartment through a gap at the mounting position of the securing shaft, reducing the service life of the compartment cover.

Therefore, there is an urgent need for a folding device that has good waterproof performance and enables more flexible and smooth rotation between adjacent cover plates, a compartment cover, and an automobile.

### SUMMARY

The present disclosure provides a folding device, improving the rotation smoothness of an engaging portion in an accommodation recess, and avoiding the occurrence of the jamming phenomenon when a connection profile rotates relative to a pivot profile.

To achieve this object, the present disclosure provides the solutions described below.

A folding device includes a pivot profile, a connection profile, and a rolling element.

The connection profile is connected to each of two sides of the pivot profile. One of the pivot profile or the connection profile is provided with an accommodation recess. The other one of the pivot profile or the connection profile is provided with an engaging portion. The engaging portion is rotatably engaged within the accommodation recess.

The rolling element is rotatably disposed between the inner wall of the accommodation recess and the engaging portion.

In an optional solution, a limiting portion is disposed on the sidewall of the accommodation recess and extends towards the engaging portion. The limiting portion is configured to limit the engaging portion in the accommodation recess.

In an optional solution, the engaging portion is provided with a first engaging recess. The rolling element is rotatably disposed in the first engaging recess.

In an optional solution, an abutment surface of one of the inner wall of the accommodation recess or the engaging portion is an abutment convex surface. The other one of the inner wall of the accommodation recess or the engaging portion is an abutment concave surface. The abutment convex surface is adapted to abut against the abutment concave surface.

In an optional solution, a sealing member is disposed on one side of the connection profile in a folding direction. The sealing member is sealingly disposed between the connection profile and the pivot profile.

In an optional solution, the folding angle between the connection profile and the pivot profile is set to be 0° to 90°.

The present disclosure further provides a compartment cover, improving the rotation flexibility of plates and ensuring the taking-in efficiency of the plates.

To achieve this object, the present disclosure provides the solutions described below.

A compartment cover including multiple plates and the preceding folding device. Two adjacent plates are connected through the folding device. A respective plate is connected to one side of the connection profile away from the pivot profile.

In an optional solution, the joint between the respective plate and the connection profile is coated with sealant.

To achieve this object, each plate is a foam board.

The present disclosure further provides an automobile with the preceding compartment cover to improve the efficiency of loading goods.

To achieve this object, the present disclosure adopts the solutions described below.

An automobile includes the preceding compartment cover.

### BRIEF DESCRIPTION OF DRAWINGS

The present disclosure is further described below in detail in conjunction with drawings and embodiments.

FIG. 1 is a partial structure view of a compartment cover in an unfolded state according to an embodiment of the present disclosure.

FIG. 2 is an exploded view of a folding device according to an embodiment of the present disclosure.

FIG. 3 is a partial structure view of the compartment cover in a folded state according to an embodiment of the present disclosure.

FIG. 4 is a partial structure view of another compartment cover in unfolded state according to an embodiment of the present disclosure.

FIG. 5 is a partial structure view of another compartment cover in a folded state according to an embodiment of the present disclosure.

### REFERENCE LIST

100 folding device
200 plate
1 pivot profile
11 accommodation recess
12 limiting portion
2 connection profile
21 engaging portion
211 first engaging recess
3 rolling element
4 sealing member

### DETAILED DESCRIPTION

In order to illustrate technical problems, technical solutions, and technical effects of the present disclosure more clearly, the technical solutions of embodiments of the present disclosure are further described below in detail in conjunction with drawings. Apparently, embodiments described herein are merely part, not all, of the embodiments of the present disclosure. Based on the embodiments of the present disclosure, all other embodiments obtained by those skilled in the art without creative work are within the scope of the present disclosure.

In the description of the present disclosure, terms “jointed”, “connected”, or “fixed” are to be construed in a broad sense unless otherwise expressly specified and limited. For example, the term “connected” may refer to “securely connected”, “detachably connected” or “integrally connected”, may refer to “mechanically connected” or “electrically connected”, or may refer to “connected directly”, “connected indirectly through an intermediary” or “intraconnected between two components or interactional between two components”. For those of ordinary skill in the art, specific meanings of the preceding terms in the present disclosure may be understood based on specific situations.

In the present disclosure, unless otherwise expressly specified and limited, when a first feature is described as “on” or “below” a second feature, the first feature and the second feature may be in direct contact or may be in contact via another feature between the two features instead of being in direct contact. Moreover, when the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

In the description of the present disclosure, it is to be noted that orientations or position relations indicated by terms such as “above”, “below”, “left” and “right” are based on the drawings. These orientations or position relations are intended only to facilitate the description and simplify the operation and not to indicate or imply that a device or element referred to must have such particular orientations or must be configured or operated in such particular orientations. Thus, these orientations or position relations are not to be construed as limiting the present disclosure. In addition, the terms “first” and “second” are used only to distinguish between descriptions and have no special meaning.

In the description of the specification, the description of reference terms “an embodiment” or “example” means that specific characteristics, structures, materials, or features described in connection with the embodiment or example are included in at least one embodiment or example of the present disclosure. In the specification, the illustrative description of the preceding terms does not necessarily refer to the same embodiment or example.

Solutions of the present disclosure are further described below through embodiments in conjunction with the drawings.

### Embodiment One

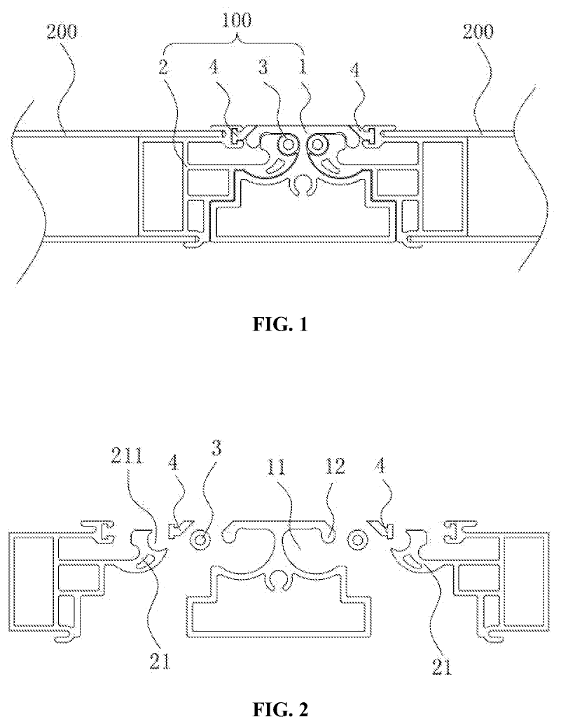

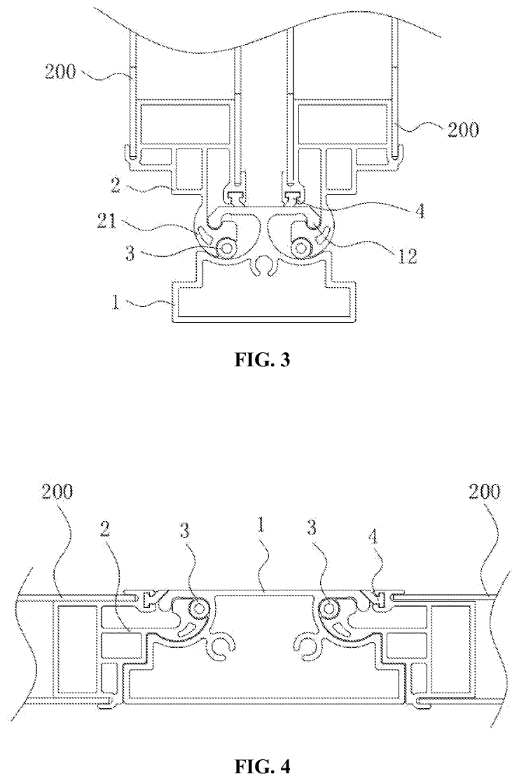

As shown in FIGS. 1 to 5, this embodiment provides a folding device 100 that can be used in a device requiring folding and stowing, for example, for the connection of plates 200 of a compartment cover, the connection of fences, the connection of household plates, and the connection of construction plates. In the present disclosure, the case where the folding device 100 is applied to the connection of the plates 200 of the compartment cover is used as an example.

The folding device 100 includes a pivot profile 1 and rolling elements 3. Each of two sides of the pivot profile 1 is connected to a connection profile 2. One of the pivot profile 1 or a respective connection profile 2 is provided with an accommodation recess 11, the other one of the pivot profile 1 or the respective connection profile 2 is provided with an engaging portion 21. The engaging portion 21 is rotatably engaged in the accommodation recess 11. A respective rolling element 3 is rotatably disposed between an inner wall of the accommodation recess 11 and the engaging portion 21.

Exemplarily, the accommodation recess 11 is disposed on the pivot profile 1, and the engaging portion 21 is disposed on the connection profile 2. When the engaging portion 21 rotates in the accommodation recess 11, the connection profile 2 can rotate relative to the pivot profile 1. Therefore, two adjacent plates 200 are connected through the folding device 100, and are connected to connection profiles 2 on two sides of the pivot profile 1 in a one-to-one correspondence, so that the two adjacent plates 200 can be turned over, folded and stowed. Moreover, the rolling element 3 is rotatably disposed between the inner wall of the accommodation recess 11 and the engaging portion 21, and the rolling element 3 can improve the rotation smoothness of the engaging portion 21 in the accommodation recess 11, and avoid the occurrence of the jamming phenomenon when the engaging portion 21 rotates in the accommodation recess 11. Further, the rolling element 3 is in rolling contact with the inner wall of the accommodation recess 11, and the rolling element 3 is also in rolling contact with the engaging portion 21. Therefore, the friction between the rolling element 3 and the engaging portion 21 and the friction between the rolling element 3 and the inner wall of the accommodation recess 11 can be reduced, reducing the friction loss, the heat caused by the friction, or the fatigue damage caused by the friction. Moreover, the water flow is less likely to seep through a gap formed by the wear after a long time of use, thereby prolonging the service life of the folding device 100.

The specific shape of the rolling element 3 is not limited in the present disclosure. Any shape that is well known to those skilled in the art and enables rotations, rolling, sliding or the like of the connection profile 2 relative to the pivot profile 1 can be selected and falls within the scope of the present disclosure by default. Optionally, the rolling element 3 is a sphere or a cylinder. Optionally, the rolling element 3 is an integrated rolling element or a split rolling element. Optionally, the rolling element 3 is a bearing.

In other application scenarios of the present disclosure, the accommodation recess is provided on the connection profile 2, and the engaging portion is disposed on the pivot profile 1.

Optionally, a limiting portion 12 is disposed on a sidewall of the accommodation recess 11 and extends towards the engaging portion 21. The limiting portion 12 is configured to limit the engaging portion 21 in the accommodation recess 11.

Specifically, the limiting portion 12 is disposed on the pivot profile 1. The limiting portion 12 extends towards the root portion of the engaging portion 21, and thus can limit the engaging portion 21 within the accommodation recess 11, avoiding the connection profile 2 from being disengaged from the pivot profile 1 due to complete disengagement of the engaging portion 21 from the accommodation recess 11.

In other application scenarios of the present disclosure, the limiting portion is disposed on the connection profile 2.

Preferably, to ensure smooth rotation of the engaging portion 21 throughout the whole rotating process, the engaging portion 21 is provided with a first engaging recess 211, and the rolling element 3 is rotatably disposed in the first engaging recess 211. When the engaging portion 21 rotates in the accommodation recess 11, the rolling element 3 is limited in the first engaging recess 211 so that the rolling element 3 can rotate relative to the inner wall of the accommodation recess 11 along with the engaging portion 21.

Optionally, an abutment surface of one of the engaging portion 21 or the inner wall of the accommodation recess 11 is an abutment convex surface, and an abutment surface of the other one of the engaging portion 21 or the inner wall of the accommodation recess 11 is an abutment concave surface. The abutment convex surface is adapted to abut against the abutment concave surface.

Optionally, the abutment concave surface is any concave surface with smooth transition such as a circular-arc concave surface or an elliptical concave surface, and the abutment convex surface is any convex surface with smooth transition such as a circular-arc convex surface or an elliptical convex surface.

Exemplarily, the abutment surface of the engaging portion 21 is an abutment convex surface, and the abutment surface of the inner wall of the accommodation recess 11 is an abutment concave surface, so that the rotation smoothness of the engaging portion 21 within the accommodation recess 11 can be improved by using the smooth transition contact.

In other application scenarios of the present disclosure, the abutment surface of the engaging portion 21 is an abutment concave surface, and the inner wall of the accommodation recess 11 is an abutment convex surface.

To avoid rainwater from seeping into the accommodation recess 11 and affecting the rotation efficiency of the engaging portion 21 within the accommodation recess 11, a sealing member 4 is disposed on one side of the connection profile 2 in the folding direction. The sealing member 4 is sealingly disposed between the connection profile 2 and the pivot profile 1. As shown in FIGS. 1, 3, 4 and 5, the sealing member 4 is located at the top of the folding device 100 in use, and the rotation direction for folding and stowing the connection profile 2 is to turn the connection profile 2 to the top of the pivot profile 1. The sealing member 4 is fixedly connected to one of the connection profile 2 or the pivot profile 1, and is closely abutted against the other one of the connection profile 2 or the pivot profile 1.

Optionally, the sealing member 4 is made of a rubber material. The elastic deformability of the rubber material ensures that the gap between the connection profile 2 and the pivot profile 1 can always be sealed when the connection profile 2 rotates relative to the pivot profile 1.

Optionally, a folding angle between the connection profile 2 and the pivot profile 1 is set to be 0° to 90°. When the folding device 100 is applied, the connection profile 2 and the pivot profile 1 can be unfolded. When the folding device 100 is in an unfolded state, the folding angle between the connection profile 2 and the pivot profile 1 is 0°, and the connection profile 2 and the pivot profile 1 are in the same plane. When the folding device 100 needs to be switched to a folded and stowed state, the folding device 100 is in a folded state, the connection profile 2 rotates by 90° relative to the pivot profile 1, and the folding angle between the connection profile 2 and the pivot profile 1 is 90°.

In other application scenarios of the present disclosure, such as the connection of household plates and the connection of construction plates, the sealing member 4 is located at the bottom of the folding device 100, one folding device 100 is provided, two plates 200 are provided, and the folding angle between the connection profile 2 and the pivot profile 1 is adjusted to 30°, 45° or 60°, so that when some foreign substances such as snowflakes, dust, or rainwater fall onto the plates 200, the inclined plates 200 can direct these external objects to the ground, thereby avoiding the snowflakes from accumulating on the household plates and the construction plates, and reducing the bearing weight of the household plates and the construction plates to avoid the collapse, for example.

One side of the pivot profile 1 provided with the accommodation recess 11 is provided with an offset limiting portion for adaptively engaging with the end face of the connection profile 2 to limit the deflection of the connection profile 2 in a direction opposite to the folding direction.

### Embodiment Two

As shown in FIGS. 1, 3, 4 and 5, this embodiment provides a compartment cover including multiple plates 200 and the folding device 100 as described in embodiment one. Two adjacent plates 200 are connected through the folding device 100, thereby ensuring that the two plates 200 can be stowed smoothly without jamming.

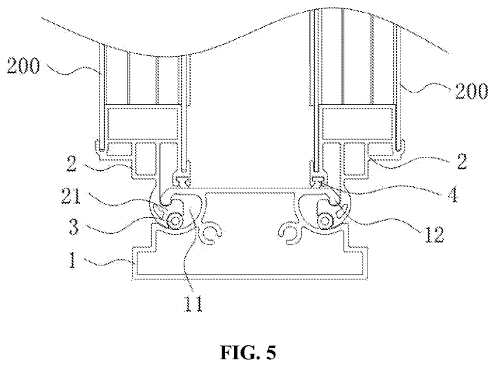

When a gap between two adjacent plates 200 is relatively small, the folding device 100 as shown in FIGS. 1 to 3 is adopted. When a gap between two adjacent plates 200 is relatively large, the folding device 100 as shown in FIGS. 4 and 5 is adopted.

Optionally, the plate 200 is connected to one side of the connection profile 2 away from the pivot profile 1, and the joint between the plate 200 and the connection profile 2 is coated with sealant to enhance the waterproof and sealing effect and ensure the aesthetic effect.

The present disclosure imposes no particular restriction on the selection of the sealant, and any sealing material known to those skilled in the art that can achieve the waterproof and sealing effect can be adopted.

Optionally, one of the connection profiles 2 or the plate 200 is provided with an engaging recess, and the other one of the connection profiles 2 or the plate 200 is provided with an engaging block. After the engaging block is engaged with the engaging recess, the sealant is applied into the engaging recess, thereby sealing the gap between the engaging block and the engaging recess. When the engaging recess is disposed on the connection profile 2, the engaging block is regarded as a sidewall of the plate 200. After the sidewall of the plate 200 is accommodated in the engaging recess, the sealant is applied to the engaging recess to achieve sealing of the gap. When the engaging recess is disposed on the plate 200, the engaging block of the connection profile 2 is engaged with the engaging recess of the plate 200.

Optionally, the plate 200 is a foam board. A weight of the foam board is smaller than a weight of an existing honeycomb board, so that the plate 200 can be easily folded due to its relatively small weight resistance, and it is ensured that the plate 200 is not easily detached from the connection profile 2, or the engaging portion 21 is not easily detached from the accommodation recess 11. In addition, when defects such as bumps or pits appear on the surface of the plate 200, the plate 200 can be repaired by a negative pressure device, prolonging the service life of the compartment cover and maintaining the overall beauty of the compartment cover.

The present disclosure does not impose any restriction on the foaming process of the foam board, and any foaming process known to those skilled in the art can be adopted. The present disclosure does not impose any restriction on the foaming material of the foam board, and any foaming material known to those skilled in the art can be adopted. Optionally, the plate 200 is made of an aluminum alloy to reduce the overall weight. The inside of the board 200 is filled with a foaming agent, thereby forming the foam board.

### Embodiment Three

This embodiment provides an automobile in which a compartment cover described in embodiment two is adopted. The compartment cover covers a compartment. When the compartment cover needs to be stowed so as to load goods in the compartment, plates 200 are folded and stowed, thereby improving the efficiency of loading the goods.

In addition, the above are only preferred embodiments of the present disclosure and the principles used therein. It will be understood by those skilled in the art that the present disclosure is not limited to the specific embodiments described herein. Those skilled in the art can make various apparent changes, modifications and substitutions without departing from the scope of the present disclosure. Therefore, while the present disclosure has been described in detail through the preceding embodiments, the present disclosure is not limited to the preceding embodiments and may include more other equivalent embodiments without departing from the concept of the present disclosure. The scope of the present disclosure is determined by the scope of the appended claims.

What is claimed is:

1. A folding device: comprising:
a pivot profile;
a connection profile connected to each of two sides of the pivot profile, wherein one of the pivot profile or the connection profile is provided with an accommodation recess, the other one of the pivot profile or the connection profile is provided with an engaging portion, and the engaging portion is rotatably engaged within the accommodation recess; and
a rolling element rotatably disposed between the engaging portion and an inner wall of the accommodation recess.

2. The folding device according to claim 1, further comprising a limiting portion disposed on a sidewall of the accommodation recess that extends towards the engaging portion, and the limiting portion is configured to limit the engaging portion in the accommodation recess.

3. The folding device according to claim 1, wherein the engaging portion is provided with a first engaging recess, and the rolling element is rotatably disposed in the first engaging recess.

4. The folding device according to claim 1, wherein an abutment surface of one of an inner wall of the accommodation recess or the engaging portion is an abutment convex surface, the other one of the inner wall of the accommodation recess or the engaging portion is an abutment concave surface, and the abutment convex surface is adapted to abut against the abutment concave surface.

5. The folding device according to claim 1, further comprising a sealing member disposed on one side of the connection profile in a folding direction, and the sealing member is sealingly disposed between the connection profile and the pivot profile.

6. The folding device according to claim 1, wherein a folding angle between the connection profile and the pivot profile is set to be 0° to 90°.

7. A compartment cover, comprising: a plurality of plates and the folding device of claim 1, wherein two adjacent ones of the plurality of plates are connected through the folding device, and a respective one of the plates is connected to one side of the connection profile away from the pivot profile.

8. The compartment cover according to claim 7, wherein a joint between the respective plate and the connection profile is coated with sealant.

9. The compartment cover according to claim 7, wherein each of the plurality of plates is a foam board.

10. An automobile, comprising: the compartment cover of claim 7.

11. A compartment cover, comprising: a plurality of plates and the folding device of claim 2, wherein two adjacent ones of the plurality of plates are connected through the folding device, and a respective one of the plates is connected to one side of the connection profile away from the pivot profile.

12. A compartment cover, comprising: a plurality of plates and the folding device of claim 3, wherein two adjacent ones of the plurality of plates are connected through the folding device, and a respective one of the plates is connected to one side of the connection profile away from the pivot profile.

13. A compartment cover, comprising: a plurality of plates and the folding device of claim 4, wherein two adjacent ones of the plurality of plates are connected through the folding device, and a respective plate is connected to one side of the connection profile away from the pivot profile.

14. A compartment cover, comprising: a plurality of plates and the folding device of claim 5, wherein two adjacent ones of the plurality of plates are connected through the folding device, a respective one of the plates is connected to one side of the connection profile away from the pivot profile.

15. A compartment cover, comprising: a plurality of plates and the folding device of claim 6, wherein two adjacent ones of the plurality of plates are connected through the folding device, and a respective one of the plates is connected to one side of the connection profile away from the pivot profile.

16. An automobile, comprising: the compartment cover of claim 8.

17. An automobile, comprising: the compartment cover of claim 9.
